(19) United States
(12) Patent Application Publication
(10) Pub. No.: US 2013/0282147 A1
(43) Pub. Date: Oct. 24, 2013

(54) SYSTEM AND METHOD FOR PROCESS MONITORING AND CONTROL

(71) Applicants: MUNEEB A. AKRAM, DHAHRAN (SA); ABDULWAHID A. SAIF, DHAHRAN (SA)

(72) Inventors: MUNEEB A. AKRAM, DHAHRAN (SA); ABDULWAHID A. SAIF, DHAHRAN (SA)

(73) Assignee: KING FAHD UNIVERSITY OF PETROLEUM AND MINERALS, DHAHRAN (SA)

(21) Appl. No.: 13/453,821

(22) Filed: Apr. 23, 2012

(51) Int. Cl. G05B 13/02

(52) U.S. Cl. 700/32

(57) ABSTRACT

The system for process monitoring and control integrates statistical process control (SPC) with automatic process control (APC) through the use of a fuzzy logic (FZL) controller. In order to relate the inputs to the output, fuzzy inference rules are applied. The fuzzy rules are based on the use of the APC controller during normal situations, deviating to SPC as soon as abnormalities are detected. When the output error is negligible and the change in the output quality characteristic is almost zero, the fuzzy logic controller (FZLC) provides a utilization factor parallel for applying the APC controller. The FZLC has two inputs: the output error erₜ and the rate of change of the output quality characteristic dyₜ. The FZLC has a single output: the controller utilization factor wₜ. When erₜ is large and dyₜ is high, the controller utilization factor wₜ will utilize the application of the SPC controller.

### BACKGROUND OF THE INVENTION

1. Field of the Invention

The present invention relates to automated control techniques, and particularly to a system and method for process monitoring and control utilizing fuzzy logic control to integrate automatic process control with statistical process control.

2. Description of the Related Art

Statistical process control (SPC) is the application of statistical methods to the monitoring and control of a process to ensure that it operates at its full potential to produce conforming product. Under SPC, a process behaves predictably to produce as much conforming product as possible with the least possible waste. While SPC has been applied most frequently to controlling manufacturing lines, it applies equally well to any process with a measurable output. Key tools in SPC are control charts, a focus on continuous improvement, and designed experiments.

Much of the power of SPC lies in the ability to examine a process and the sources of variation in that process using tools that give weight to objective analysis over subjective opinions and that allow the strength of each source to be determined numerically. Variations in the process that may affect the quality of the end product or service can be detected and corrected, thus reducing waste, as well as the likelihood that problems will be passed on to the customer. With its emphasis on early detection and prevention of problems, SPC has a distinct advantage over other quality methods, such as inspection, that apply resources to detecting and correcting problems after they have occurred.

In addition to reducing waste, SPC can lead to a reduction in the time required to produce the product or service from end to end. This is partially due to a diminished likelihood that the final product will have to be reworked, but it may also result from using SPC data to identify bottlenecks, wait times, and other sources of delays within the process. Process cycle time reductions coupled with improvements in yield have made SPC a valuable tool from both a cost reduction and a customer satisfaction standpoint.

Statistical Process Control may be broadly broken down into three sets of activities: understanding the process, understanding the causes of variation, and elimination of the sources of special cause variation. In understanding a process, the process is typically mapped out and the process is monitored using control charts. Control charts are used to identify variation that may be due to special causes, and to free the user from concern over variation due to common causes. This is a continuous, ongoing activity. When a process is stable and does not trigger any of the detection rules for a control chart, a process capability analysis may also be performed to predict the ability of the current process to produce conforming (i.e. within specification) product in the future action.

When excessive variation is identified by the control chart detection rules, or the process capability is found lacking, additional effort is exerted to determine causes of that variance. The tools used include Ishikawa diagrams, designed experiments and Pareto charts. Designed experiments are critical to this phase of SPC, as they are the only means of objectively quantifying the relative importance of the many potential causes of variation.

Once the causes of variation have been quantified, effort is spent in eliminating those causes that are both statistically and practically significant (i.e., a cause that has only a small but statistically significant effect may not be considered cost-effective to fix; however, a cause that is not statistically significant can never be considered practically significant). Generally, this includes development of standard work, error-proofing and training. Additional process changes may be required to reduce variation or align the process with the desired target, especially if there is a problem with process capability.

For digital SPC charts, so-called “SPC rules” usually come with some rule specific logic that determines a “derived value” that is to be used as the basis for some setting correction. Most SPC charts work best for numeric data with Gaussian assumptions.

SPC is traditionally applied to processes that vary about a fixed mean, and where successive observations are viewed as independent. The SPC approach seeks to reduce variability by detecting and eliminating assignable causes of variation. SPC can be viewed as a top-down tool that is usually driven by upper management as part of a company wide quality improvement policy. The role of SPC is to change the process when assignable causes occur. SPC does not control the process, but performs a monitoring function that signals when control is needed (identification and removal of root causes).

On the other hand, automatic process control (APC) is usually applied to processes in which successive observations are related over time, and where the mean drifts dynamically. APC seeks to reduce variability by transferring it from the output variable to a related process input (i.e., controllable) variable. It actively reverses the effect of process disturbances by making regular adjustments to manipulatable process variables. APC is usually discussed in the framework of a process with a drifting mean, and the objective of the process adjustment is to keep the output quality characteristic on target. APC is viewed as a bottom-up procedure driven by process control or manufacturing engineers. The role of APC is to continuously adjust the process to counteract ongoing forces that will cause the process to drift off-target if compensations are not made. APC does not remove the root or assignable causes. Rather, it uses continuous adjustments to keep process variables on targets.

SPC and APC systems were initially thought to be incompatible. However, there have recently been advances in the integration of the two. Most integration schemes involve the use of SPC techniques for monitoring functions and APC techniques for process regulation. Other attempts have involved the derivation of SPC controllers that are used alone, which does not result in true integration. It would be desirable to provide a truly integrated SPC and APC process monitoring and control system.

Thus, a system and method for process monitoring and control solving the aforementioned problems is desired.

### SUMMARY OF THE INVENTION

The system for process monitoring and control integrates statistical process control (SPC) with automatic process control (APC) through the use of a fuzzy logic (FZL) controller. In order to relate the inputs to the output, fuzzy inference rules are applied, the fuzzy rule base being based on applying the use of the APC controller during normal situations, and then deviating to SPC as soon as abnormalities are first detected. For example, when the output error is negligible and the change in the output quality characteristic is almost zero, the fuzzy logic controller (FZLC) will provide a utilization factor parallel for applying the APC controller. The FZLC has two inputs: the output error erₜ, and the rate of change of the output quality characteristic dyₜ. The FZLC has a single output; the controller utilization factor wₜ. When erₜ is large and dyₜ is high, the controller utilization factor wₜ will utilize the application of the SPC controller.

These and other features of the present invention will become readily apparent upon further review of the following specification and drawings.

### BRIEF DESCRIPTION OF THE DRAWINGS

FIG. 1 is a block diagram illustrating components of a system for process monitoring and control according to the present invention.

FIG. 2 is a block diagram illustrating the basic architecture of a fuzzy logic controller of the system for process monitoring and control.

FIG. 3 is a graph illustrating membership functions for the first input (output error) of the fuzzy logic controller of FIG. 2.

FIG. 4 is a graph illustrating membership functions for the second input (rate of change of output) of the fuzzy logic controller of FIG. 2.

FIG. 5 is a graph illustrating membership functions for the controller output of the fuzzy logic controller of FIG. 2.

FIG. 6 diagrammatically illustrates an exemplary pH control process for monitoring and control by the system and method for process monitoring and control according to the present invention.

FIG. 7 is a graph illustrating control output response of a prior proportional-integral-derivative (PID) controller.

FIG. 8 is a table showing experimental control results of the prior PID controller.

FIG. 9 is a graph illustrating control output response of a prior robust PID controller.

FIG. 10 is a graph comparing control output responses of the prior PID controller, a prior statistical process controller (SPC), and the present system for process monitoring and control.

FIG. 11 is an exponentially weighted moving average (EWMA) control chart for the prior PID controller.

FIG. 12 is an EWMA control chart for the prior SPC controller.

FIG. 13 is an EWMA control chart for the present system for process monitoring and control.

Similar reference characters denote corresponding features consistently throughout the attached drawings.

### DETAILED DESCRIPTION OF THE PREFERRED EMBODIMENTS

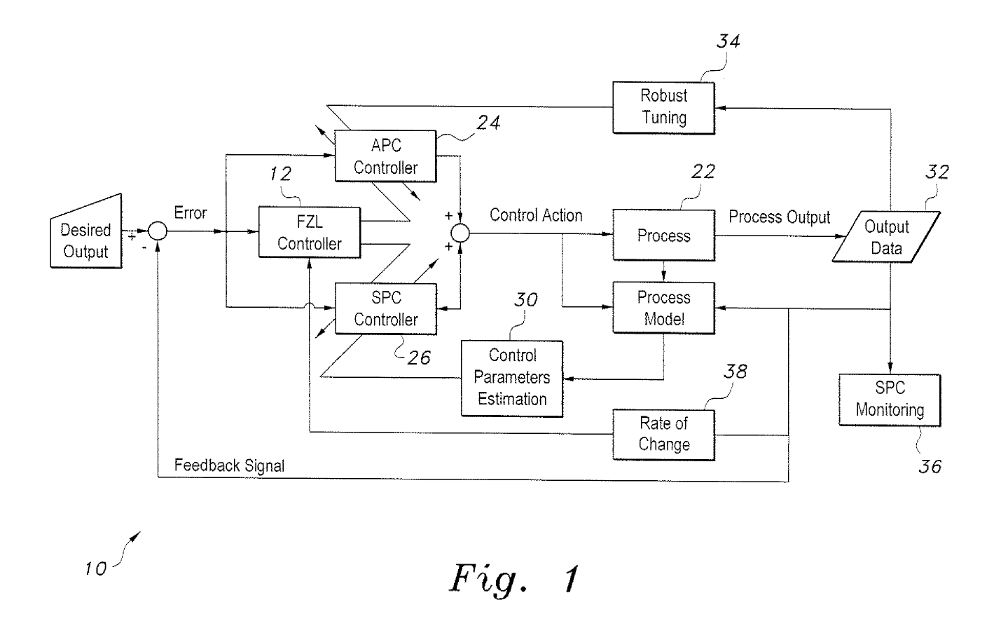

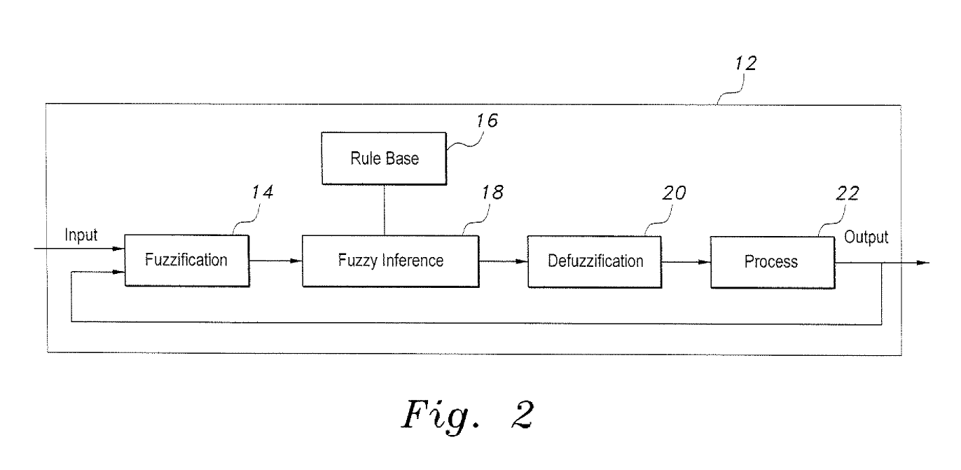

FIG. 1 diagrammatically illustrates the system for process monitoring and control, generally indicated by reference number 10. The system 10 integrates statistical process control (SPC) with automatic process control (APC) through the use of a fuzzy logic (FZL) controller 12. FIG. 2 diagrammatically illustrates the architecture of a generalized fuzzy logic controller, suitable for use as fuzzy logic controller 12 of FIG. 1.

Fuzzy logic is a formal methodology for representing, manipulating, and implementing a human's heuristic knowledge regarding how best to control a process. Fuzzy logic is defined as a mathematical system that analyzes analog input values in terms of logical variables that take on continuous values between 0 and 1, in contrast to classical or digital logic, which operates on discrete values of either 0 or 1 (i.e., true or false). The basic idea behind fuzzy logic is to mimic the fuzzy feature of human thinking for the effective control of uncertain systems through fuzzy logic reasoning. Fuzzy logic has the advantage that the solution to the problem can be cast in terms that human operators can understand, so that their experience can be used in the design of the controller. This makes it easier to mechanize tasks that are already successfully performed by humans. Furthermore, fuzzy logic is well suited to low-cost implementations based on relatively inexpensive sensors, low-resolution converters, and microcontroller chips. Such systems may be easily upgraded by adding new rules to improve performance, or by adding new features.

A fuzzy logic control (FZLC) system is a control system based on fuzzy logic. Fuzzy logic controllers, such as controller 12 of FIGS. 1 and 2, are known and are used in various control schemes. Such controllers are used to improve existing traditional controller systems by adding an extra layer of intelligence to the current control method. The most obvious type of FZLC is direct control, where the fuzzy controller is kept in the forward, within the feedback control system. Typically, the process output is compared with a reference, and if there is any deviation, the controller takes action as per the designed control strategy. FIG. 2 shows the generalized architecture of the fuzzy logic controller 12, which includes four modules: a fuzzification module 14, which converts crisp input and output signals into a plurality of fuzzy represented values (i.e., fuzzy sets); a rule base module 16, which represents an expert's knowledge in the form of “if-then” logical rule structures; a fuzzy inference module 18, which provides a mechanism for referring to the rule base 16 so that appropriate rules are applied; and a deffuzification module 20, which produces a non-fuzzy control action that represents the membership function of an inferred fuzzy control action. The non-fuzzy control action then controls, in a conventional manner, the particular process to which control is applied (represented generally as block 22 in FIG. 2).

The input variables in a fuzzy control system are generally mapped by sets of membership functions, known as “fuzzy sets”. Given mappings of input variables into membership functions along with their truth values, the controller 12 can make decisions about which action is to be taken based on a set of rules, which are typically expressed in conventional logical form, such as “IF variable IS property THEN action”. The AND, OR, and NOT operators of Boolean logic can also exist in FZL, and are usually defined as the minimum, maximum, and complement, respectively. This combination of fuzzy operations and rule-based inference describes a fuzzy expert system, such as the system 10.

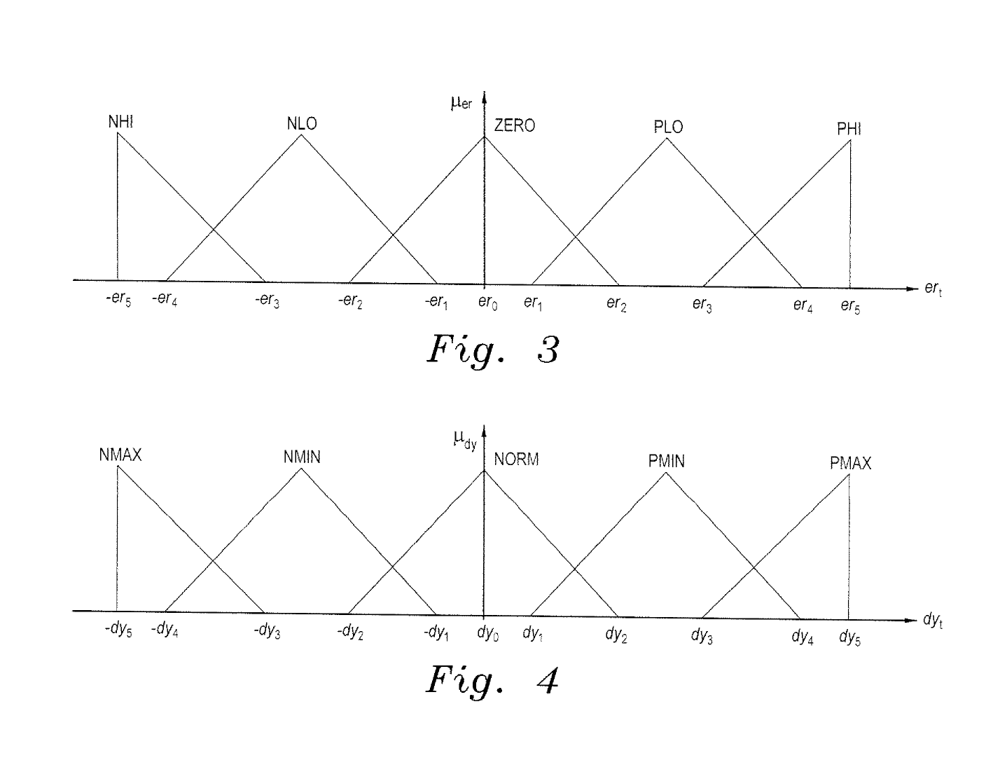

Referring to FIG. 2, the FZLC 12 has two inputs applied to the fuzzification module 14, i.e., the output error erₜ and the rate of change of the output quality characteristic dyₜ. The FZLC 12 has a single output: the controller utilization factor wₜ. The first input, which is en, is divided into five membership functions: Negative High (NHI), Negative Low (NLO), Zero (ZERO), Positive Low (PLO), and Positive High (PHI), as illustrated in FIG. 3.

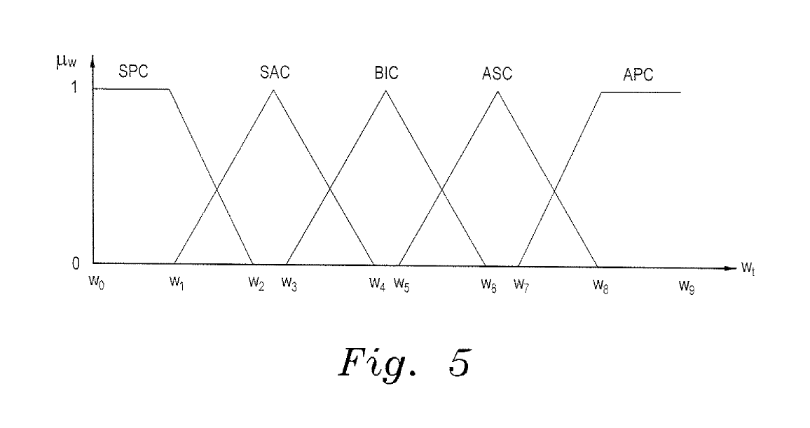

As shown in FIG. 4, five membership functions are developed for the second input dyₜ: Negative Maximum (NMAX), Negative Minimum (NMIN), Normal (NORM), Positive Minimum (PMIN), and Positive Maximum (PMAX). For the FZLC output wₜ, five membership functions are created: Statistical Process Control (SPC), Larger Statistical Control (SAC), Both Control Schemes (BIC), Larger Automatic Control (ASC), and Automatic Process Control (APC), as illustrated in FIG. 5.

In order to relate the inputs to the output, fuzzy inference rules are developed. For system 10, a rule base 16 is based on applying the use of the APC controller during normal situations, and then deviating to SPC as soon as abnormalities begin to occur. For example, when the output error is negligible and the change in the output quality characteristic is almost zero, the FZLC 12 will provide a utilization factor parallel for applying APC controller 24. However, when erₜ is large and dyₜ is high, the wₜ will utilize the application of SPC controller 26. For system 10, the following set of 25 rules is utilized:

1. If (erₜ is NMAX) and (dyₜ is NHI) then (wₜ is BIC);

2. If (erₜ is NMAX) and (dyₜ is NLO) then (wₜ is SAC);

3. If (erₜ is NMAX) and (dyₜ is ZERO) then (wₜ is SPC);

4. If (erₜ is NMAX) and (dyₜ is PLO) then (wₜ is SPC);

5. If (erₜ is NMAX) and (dyₜ is PHI) then (wₜ is SPC);

6. If (erₜ is NMIN) and (dyₜ is NHI) then (wₜ is BIC);

7. If (erₜ is NMIN) and (dyₜ is NLO) then (wₜ is SAC);

8. If (erₜ is NMIN) and (dyₜ is ZERO) then (wₜ is SAC);

9. If (erₜ is NMIN) and (dyₜ is PLO) then (wₜ w is SAC);

10. If (erₜ is NMIN) and (dyₜ is PHI) then (wₜ is SPC);

11. If (erₜ is ZERO) and (dyₜ is NHI) then (wₜ is SPC);

12. If (erₜ is ZERO) and (dyₜ is NLO) then (wₜ is SAC);

13. If (erₜ is ZERO) and (dyₜ is ZERO) then (wₜ is APC);

14. If (erₜ is ZERO) and (dyₜ is PLO) then (wₜ is SAC);

15. If (erₜ is ZERO) and (dyₜ is PHI) then (wₜ is SPC);

16. If (erₜ is PMIN) and (dyₜ is NHI) then (wₜ is SPC);

17. If (erₜ is PMIN) and (dyₜ is NLO) then (wₜ is SAC);

18. If (erₜ is PMIN) and (dyₜ is ZERO) then (wₜ is SAC);

19. If (erₜ is PMIN) and (dyₜ is PLO) then (wₜ is SAC);

20. If (erₜ is PMIN) and (dyₜ is PHI) then (wₜ is BIC);

21. If (erₜ is PMAX) and (dyₜ is NHI) then (wₜ is SPC);

22. If (erₜ is PMAX) and (dyₜ is NLO) then (wₜ is SPC);

23. If (erₜ is PMAX) and (dyₜ is ZERO) then (wₜ is SPC);

24. If (erₜ is PMAX) and (dyₜ is PLO) then (wₜ is SAC); and

25. If (erₜ is PMAX) and (dyₜ is PHI) then (wₜ is BIC).

Table 1 below summarizes the rule base 16:

TABLE 1
Fuzzy inference rules

| Output | Rate of change of output quality characteristic dyₜ | | | | |
|---|---|---|---|---|---|
| Error erₜ | NHI | NLO | ZERO | PLO | PHI |
| NMAX | BIC | SAC | SPC | SPC | SPC |
| NMIN | BIC | SAC | SAC | SAC | SPC |
| NORM | SPC | SAC | APC | SAC | SPC |
| PMIN | SPC | SAC | SAC | SAC | BIC |
| PMAX | SPC | SPC | SPC | SAC | BIC |

In the above, it should be noted that rule 13 is conditionally based upon dyₜ being ZERO, rather than NORM. The NORM value is equivalent to dyₜ=0 (see also rules 3, 8, 18, and 23, where ZERO is used as the equivalent of NORM as a membership function of the second input dyₜ). As will be described in greater detail below, essentially, the system 10 applies the above set of fuzzy inference rules so that normally process monitoring and control of the monitored process is controlled by the automatic process controller 24, and the controller utilization factor wₜ mandates control by the automatic process controller 24 when the output error erₜ is negligible and the output quality characteristic dyₜ is almost zero. However, when the output error erₜ is large and the output quality characteristic dyₜ is high, the controller utilization factor wₜ mandates control by the statistical process controller 26. Intermediate values of the output error erᵣ and the output quality characteristic dyₜ may dictate a shift to larger control by the automatic process controller 24, larger control by the statistical process controller 26, or control by both the automatic process controller 24 and the statistical process controller 26. These, however, are general tendencies, and reference should be made to rules 1-25 and Table 1 for specific fuzzy rules. It should be noted that although a membership function for ASC (larger automatic control) is established, an ASC output is not shown. The only case for which pure automatic control is applied is when both erₜ and dyₜ are zero.

In the FZLC 12, the center of area (COA) method is used by the defuzzification module 20. This method calculates the center of gravity of the distribution for the control action, which is mathematically expressed as:

$${Z}^{*} = \frac{{\sum }_{j = 1}^{q} {z}_{j} {μ}_{c} ( {z}_{j} )}{{\sum }_{j = 1}^{q} {μ}_{c} ( {z}_{j} )} , \qquad ( 1 )$$

where Z* represents the number of quantization levels of the output, zⱼ is the amount of control output at the quantization level j, and μ_{c}(zⱼ) represents its membership value in C.

Automatic process controllers, statistical process controllers and fuzzy logic controllers are all known. It should be understood that APC 24, SPC 26 and FZLC 12 may be any suitable type of controllers. Such controllers are shown in U.S. Pat. Nos. 4,344,128; 5,862,054; 6,078,911; 6,330,484; 6,424,876; 6,446,357; 7,469,195; and 7,957,821, each of which is herein incorporated by reference in its entirety.

In the following, the Absolute Efficiency (AE) is used as a performance index. This index measures the absolute efficiency of variation reduction, which is expressed as:

$$AE = \frac{{σ}_{D}}{{σ}_{e}} , \qquad ( 2 )$$

where σ_{D} is the standard deviation of the disturbance, and σₑ is the standard deviation of the controlled output,

As shown in FIG. 1, the system 10 includes a robust, tuned APC controller 24, an SEC controller 26, and an FZL controller 12, providing an overall monitoring and control system. The FZLC 12 acts as a supervisory controller that provides an output wₜ to alternately and automatically select use of the SPC controller 26 or the APC controller 24 or both according to current conditions. The final control action is given by:

u(t)=w(t)·u_{APC}(t)+[1−w(t)]·u_{SPC}(t), (3)

where u(t) represents the final control action, u_{SPC} (t) represents the control action from the SPC controller 26, u_{APC}(t) represents the control action from the APC controller 24, and w(t) is the controller factor, where 0≦w(t)≦1. As shown in FIG. 1, the joint control action signals from the APC controller 24 and the SPC controller 26 control not only the overall process (represented as block 22), but are also fed to a process model 28, which allows the control parameters to be estimated (shown as block 30). The estimates of the control parameters are used as updates for the SPC controller 26. The output data 32 of the actual process 22 is used as feedback to tune the APC controller 24 (shown as block 34) and also to provide constant SPC monitoring (block 36). The output data 32 also provides the two inputs of FZLC 12, namely the output error erₜ (represented in FIG. 1 as the feedback signal delivered to FZLC 12), and the rate of change of the output quality characteristic dyₜ (represented by block 38). In the above, the APC process is used under normal circumstances, but as abnormalities arise, the SPC factor increases. A pure SPC-based system is not desirable, which is why an integrated effect expressed in terms of the fuzzy rules (SAC, BIC, etc.) is utilized.

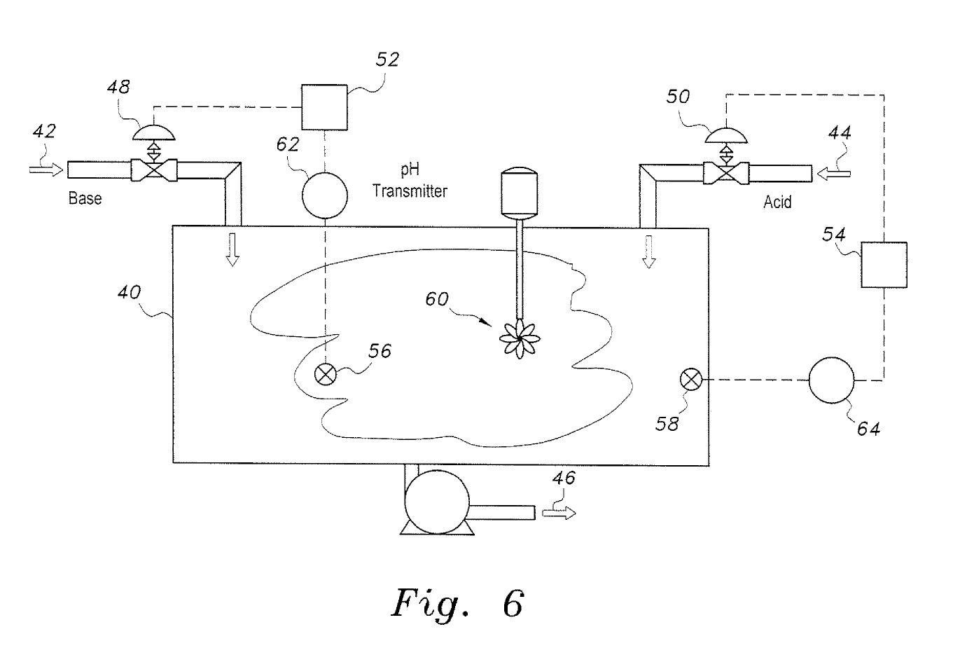

FIG. 6 diagrammatically illustrates process flow for a pH control process using monitoring and control system 10. The control of pH is very important in many processes, such as wastewater treatment, chemical and biochemical processes. From a process viewpoint, pH neutralization is a very fast and simple reaction. However, in terms of control, it has been recognized as a very difficult control problem. The difficulties arise from strong process nonlinearity, resulting from the process gain, which can change from tens to hundreds of times over a small pH range. Moreover, the load changes frequently as the influent component varies.

The process can further be affected by noises, disturbances and environmental changes, such as external temperature changes. In order to overcome such factors, it is required to have a workable pH control methodology that combines maintaining the product quality on target, maintaining the controller performance, and keeping the system robust against external factors. As shown in FIG. 6, an exemplary pH control system includes a continuously stirred tank reactor (CSTR) 40, two inlet streams 42, 44, one outlet stream 46, two flow control valves 48, 50, two controllers 52, 54, a pH sensor 56, a level sensor 58, and an agitator 60. It should be understood that any suitable type of controllers, pH sensor, agitator and level sensor may be utilized. Similarly, any suitable type of pH signal transmitter 62 coupling pH sensor 56 with controller 52 may be utilized, and any suitable type of level sensor transmitter 64 coupling level sensor 58 with controller 54 may be utilized.

As an example of the process illustrated in FIG. 6, the process stream 50 may contain hydrochloric acid (HCl) with flow rate Fₐ and concentration κₐ. The titrating stream 42 may contain sodium hydroxide (NaOH) with a flow rate F_{b} and concentration κ_{b}. Since the outlet stream 46 overflows from the CSTR 40, the outlet flow rate is equal to the sum of the inlet flow rates. The reaction equation for the neutralization of the acid-base reaction is as follows:

HCl+NaOH→NaCl+H₂O. (4)

The differential equations describing the pH neutralization process are as follows:

$$\begin{matrix}\frac{d y}{d t} = \frac{1}{V} [ {κ}_{a} {F}_{a} - {κ}_{0 a} ( {F}_{a} - {F}_{b} ) ] & ( 5 ) \\ \frac{d x}{d t} = \frac{1}{V} [ {κ}_{b} {F}_{b} - {κ}_{0 b} ( {F}_{a} + {F}_{b} ) ] , & ( 6 )\end{matrix}$$

where κ₀ₐ is the overall concentration containing the anion of the acid, κ_{0b} is the overall concentration containing the cation of the base, and V is the volume of the reactor. The steady-state operating conditions are given in Table 2 below:

TABLE 2
Steady-state operating conditions

| V | Fₐ | F_{b} | κₐ | κ_{b} |
|---|---|---|---|---|
| 20,000 L | 500 L/min | 7.027 L/min | 0.02 N | 2.0 N |

The pH value in the CSTR 40 is measured by pH sensor 56 and transmitted to the pH controller 52, which is preferably a proportional-integral-derivative (PID) controller, in which the control output is calculated and then sent to the flow control valve 48, which adjusts the base flow rate 42. The control objective is to maintain the pH value at the set point (pHₛₑₜ=1). The agitator 60 is also included to ensure proper mixing, and baffles may be added to prevent the formation of vortices. The overall process is described by the following first-order plus time delay (FOPTD) model:

$$p H ( s ) = \frac{{K}_{c} {e}^{- ds}}{Ts + 1} = \frac{{e}^{- 0.75 s}}{3.6 s + 1} , \qquad ( 7 )$$

where K_{c} is the gain of the process model, d is the time delay, and T is the time constant.

The reactor tank level is kept constant by an overflow control system. This is achieved by level transmitter 64, which sends the feedback signal to the flow controller 54, which calculates the output according to the PID control law, and then sends the control signal to the flow control valve 50, which adjusts the acid flow rate.

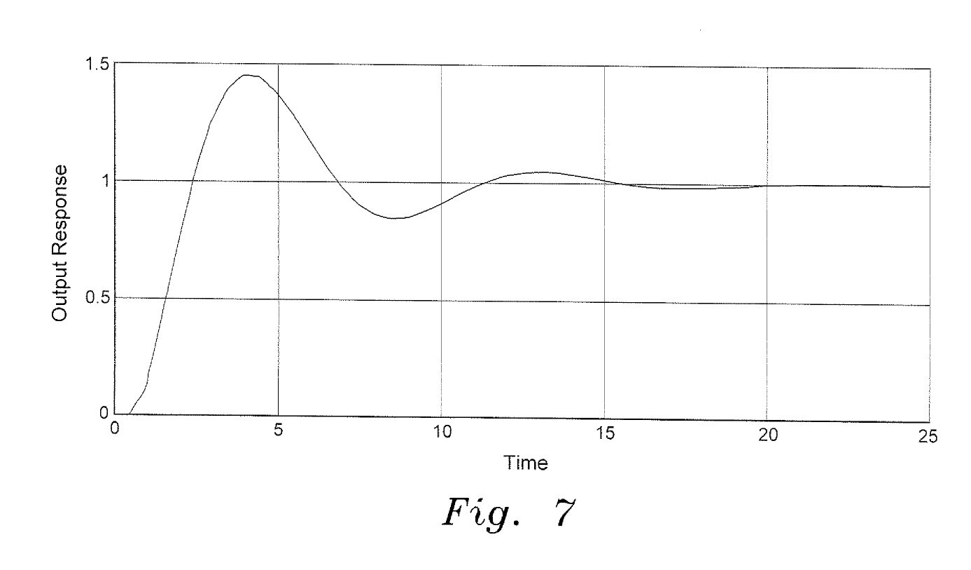

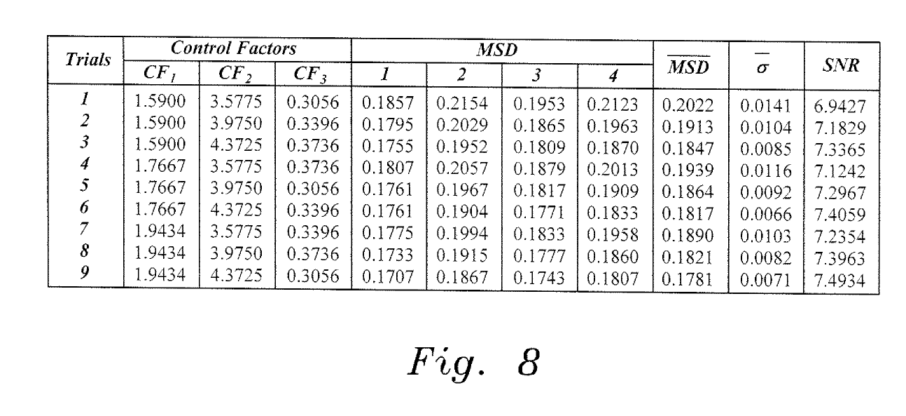

In this example, the pH controller is a PID controller with the following control parameters: Kₚ=1.7667; τᵢ=3.9750; τ_{d}=3.9750; Kᵢ=1.6000; K_{d}=0.1667. By combining the information from the FOPTD model and the PID controller settings, a block diagram for this process was built and simulated. The resulting response is shown in FIG. 7. The mean squared deviation (MSD) was found to be 0.1760, at which the signal-to-noise ratio (SNR) was found to be 7.5449, and the variance of the output was found to be 0.1604. The PID controller form in the time domain is given by

$$u ( t ) = {K}_{p} e ( t ) + \frac{{K}_{p}}{{τ}_{i}} {\int }_{0}^{t} e ( t ) d t + {K}_{p} {τ}_{d} \frac{d e ( t )}{d t} ,$$

where Kₚ is the proportional gain constant, u(t) is the control action, τᵢ is the integral time constant, τ_{d} is the derivative time constant, and e(t) is the error given as the output deviation from target of controlled variable. The discrete time equivalent for a PID controller is as follows:

$$u ( t ) = {K}_{p} [ e ( t ) + \frac{T}{{τ}_{i}} {\sum }_{k = 0}^{t} e ( k ) + \frac{{τ}_{d}}{T} ( e ( t ) - e ( t - 1 ) ) ] ,$$

where T is the time constant.

The above uses the Taguchi method for robust parameter design, which is based on the design of experiments theory, along with the use of orthogonal arrays (OAs) to study large numbers of decision variables with a small number of experiments in order to reach a near optimum parameter combination. The method classifies the inputs to the system into two types: control factors, which are factors that can be controlled and manipulated; and noise factors, which are factors that are difficult or expensive to be controlled. The basic idea underlying the Taguchi method is to exploit the interactions between the control and noise variables, and then identify the appropriate settings of the control parameters for which the system's performance is robust against variation in noise factors. The ultimate goal is to make the system response close to the target with low variation in performance.

In the Taguchi method, objective functions arise from quality measures using quadratic loss functions. The method uses the SNR as a measure of the MSD. The larger the SNR, the more robust the performance becomes. SNR is different for different types of quality characteristics. In the present method, the “smaller the better” type characteristic is utilized, where the quality characteristic never takes negative values, and its ideal value is zero. As SNR increases, the performance becomes progressively worse. Thus, SNR considers the deviation from zero, and as the name suggests, it penalizes large responses. The SNR is calculated as

$$SNR = - 10 {log}_{10} [ \frac{1}{m} ] {\sum }_{i = 1}^{m} {y}_{i}^{2} .$$

In the above, the control factors selected for the PD control rule were Kₚ, τᵢ, and τ_{d}, which may all be changed under the objective of minimizing the MSD. For each control factor, three levels are selected. The noise factors are identified from the process model itself, since these may be impossible to control. The FOPTD function is given as:

$$G ( s ) = \frac{{K}_{c} {e}^{- ds}}{Ts + 1} .$$

Thus, the noise factors are selected as K_{c}, d and T. For each noise factor, two levels are selected.

For APC controller tuning, the control factors Kₚ, τᵢ, and τ_{d} were set as shown below in Table 3:

TABLE 3
APC control factors

| Factor | Parameter | Level 1 | Level 2 | Level 3 |
|---|---|---|---|---|
| NF₁ | Kₚ | 1.5900 | 1.7667 | 1.9434 |
| NF₂ | τᵢ | 3.5775 | 3.9750 | 4.3725 |
| NF₃ | τ_{d} | 0.3056 | 0.3396 | 0.3736 |

The noise factors were identified by the process model described above in equation (7) to be K_{C}, d and T. For each factor, two levels were selected, as shown below in Table 4:

TABLE 4
APC noise factors

| Factor | Parameter | Level 1 | Level 2 |
|---|---|---|---|
| CF₁ | K_{C} | 1.0000 | 1.2500 |
| CF₂ | d | 0.7500 | 0.9375 |
| CF₃ | T | 3.6000 | 4.5000 |

After selecting the orthogonal arrays to be used (as described above with regard to the Taguchi methodology), and conducting experiments, the following results were obtained (shown below in Table 5 and in the table of FIG. 8).

TABLE 5
Experimental results - Noise Factors

| Noise factors | Trial 1 | Trial 2 | Trial 3 | Trial 4 |
|---|---|---|---|---|
| NF₁ | 1.0000 | 1.0000 | 1.2250 | 1.2250 |
| NF₂ | 0.7500 | 0.8625 | 0.7500 | 0.8625 |
| NF₃ | 3.6000 | 4.3200 | 4.3200 | 3.6000 |

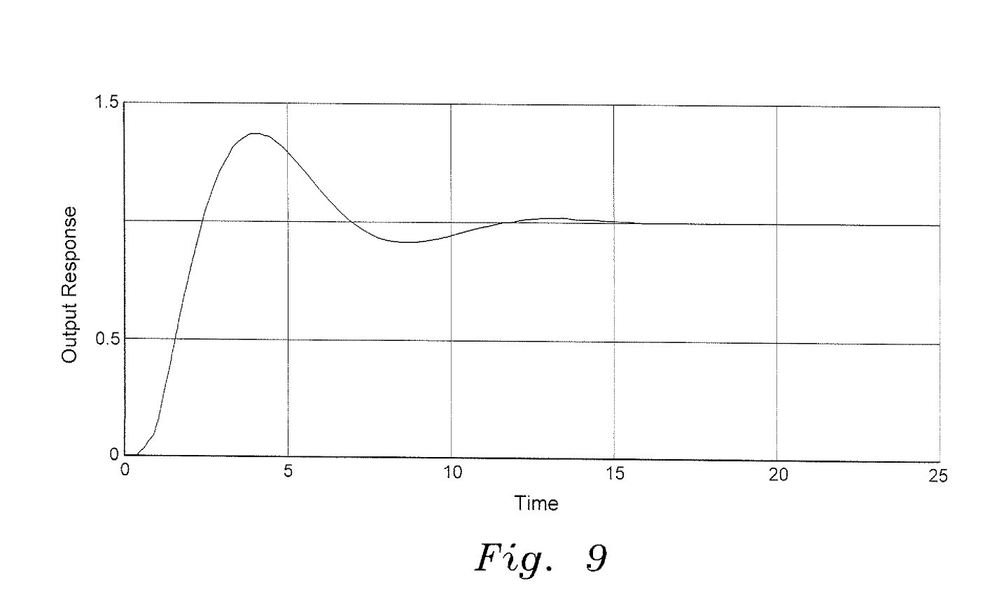

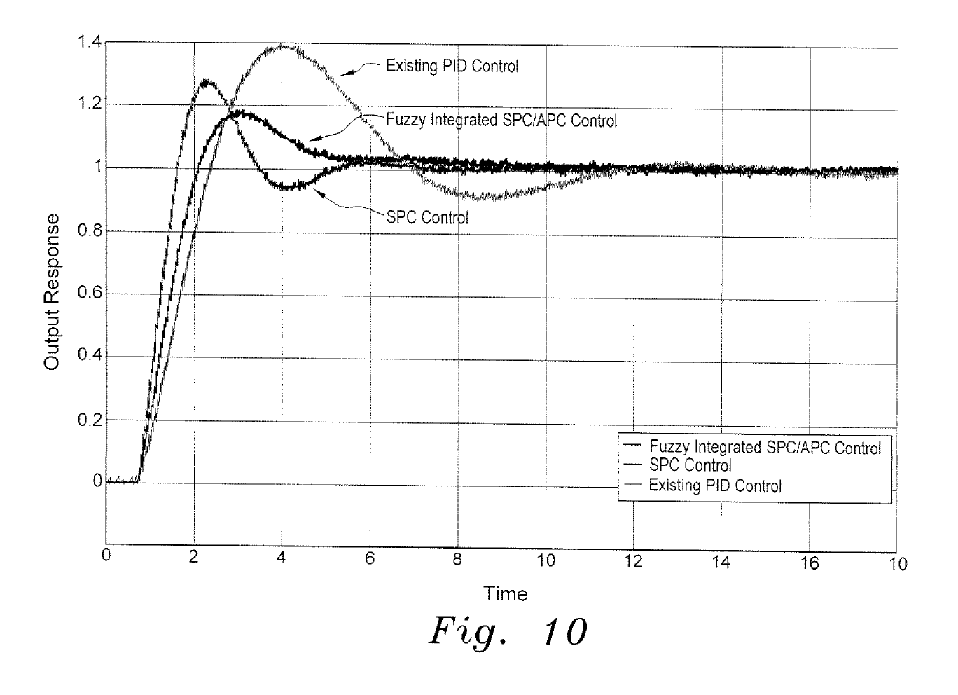

As shown in FIG. 8, the maximum value for the SNR was found to be 7.4934, at which the average MSD was found to be 0.1781. Thus, the optimum values for the robust PID controller parameters were found to be: Kₚ=1.9434, τᵢ=4.3725, τ_{d}=0.3056, Kᵢ=1.4546, and K_{d}=0.1500. The output response for the process under these settings is shown in FIG. 9. The MSD was found to be 0.1707, the SNR was found to be 7.6777, and the variance of the output was found to be 0.1540. By comparison with results obtained under the exiting control scheme, the SNR was increased by 10.02% and the variability was reduced by 3.99%. The results are found to show greater improvement when the process is subjected to operations under assignable causes.

For the SPC process model utilized, the process is described by a linear transfer function having an error term incorporated therein. It is derived by extracting the information from the closed loop process input and output data, and then deriving the process model by using linear regression, as y(t)=b₀+b₁u(t)+e(t), where u(t) is the input (control action), y(t) is the output (measured quality characteristic), e(t) is the error (deviation of the process output from the target), and b₀, b₁ are model parameters, which are estimated as

$${b}_{1} = \frac{Σ uy - n \overline{uy}}{Σ {u}^{2} - {n ( \overline{u} )}^{2}}$$

$$and$$

$${b}_{0} = \overline{y} - {b}_{1} \overline{u} .$$

From the experimental results above, the extracted data from the closed loop step response allowed for the calculation of model parameters b₀, b₁, yielding a process model of the following form:

y(t)=1 2775−0.2467x(t)+e(t). (8)

The control action u(t) is given by

$$u ( t ) = \frac{{b}_{1} [ τ ( t ) - e ( t ) - {b}_{0} ]}{{b}_{1}^{2} + φ} ,$$

where φ is an adjustment factor. Thus, for the experimental data given above, the control action is given by:

$$u ( t ) = \frac{- 0.2467 [ τ ( t ) - e ( t ) - 1.2775 ]}{0.07386} . \qquad ( 9 )$$

The FZLC is constructed as described above with regard to Table 1 and equation (1). For fuzzification, the membership functions for erₜ, dyₜ and wₜ are set according to the values below in Table 6. The 25 fuzzy inference rules of Table 1 were applied, and the COA method was used for defuzzification (equation (1)):

TABLE 6
Fuzzy logic controller settings

| erᵢ | Value | dyᵢ | Value | wᵢ | Value |
|---|---|---|---|---|---|
| er₀ | 0.000 | dy₀ | 0.000 | w₀ | 0.000 |
| er₁ | 0.007 | dy₁ | 0.007 | w₁ | 0.030 |
| er₂ | 0.010 | dy₂ | 0.010 | w₂ | 0.050 |
| er₃ | 0.035 | dy₃ | 0.035 | w₃ | 0.300 |
| er₄ | 0.040 | dy₄ | 0.040 | w₄ | 0.400 |
| er₅ | 0.500 | dy₅ | 0.500 | w₅ | 0.600 |
| | | | | w₆ | 0.700 |
| | | | | w₇ | 0.950 |
| | | | | w₈ | 0.970 |
| | | | | w₉ | 1.000 |

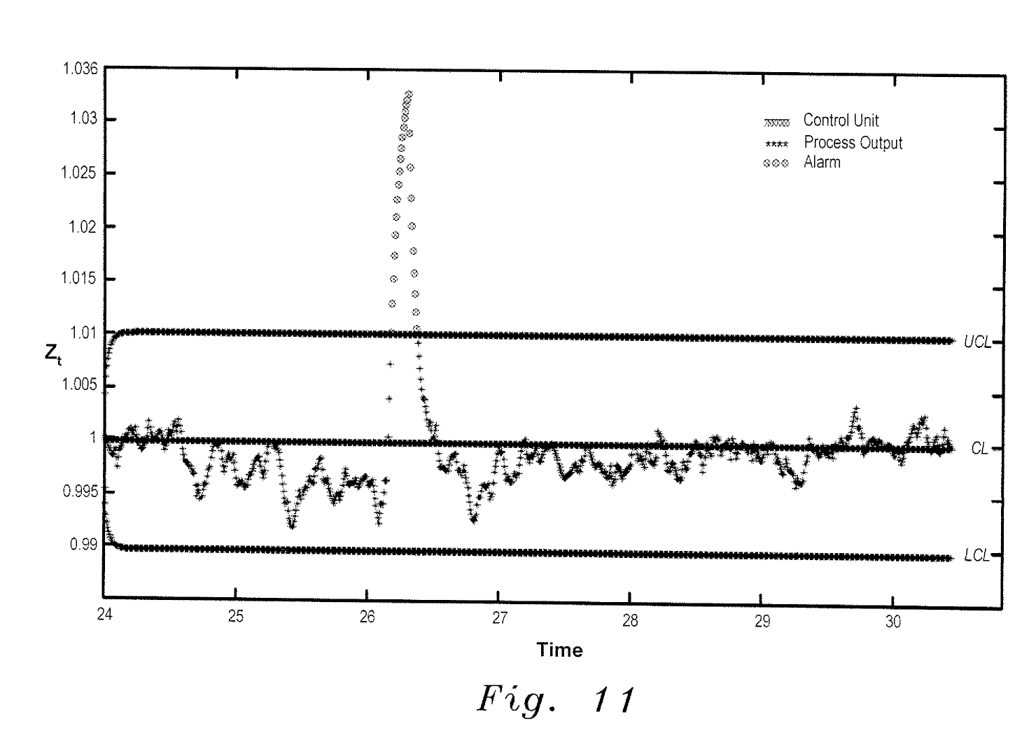

The process was simulated to operate by all three control schemes separately, including: the existing PID control, the SPC control, and the fuzzy integrated SPC/APC control of system 10. The output responses for the three control schemes are compared in FIG. 10 and the output statistics are summarized below Table 7:

TABLE 7
Summary of results

| Control scheme | MSD | SNR | AE |
|---|---|---|---|
| PID control | 0.0798 | 10.9800 | 0.7187 |
| SPC control | 0.0547 | 12.6201 | 0.8841 |
| Fuzzy integrated SPC/APC | 0.0552 | 12.5806 | 0.9123 |

By comparing the output under the fuzzy integrated SPC/APC system 10 to the output under the existing PID control scheme, the results indicate a decrease of 30.83% in MSD, an increase of 14.58% in the SNR, and an increase of 12.69% in the AE. These results improve even further when the process is derived under SPC control action.

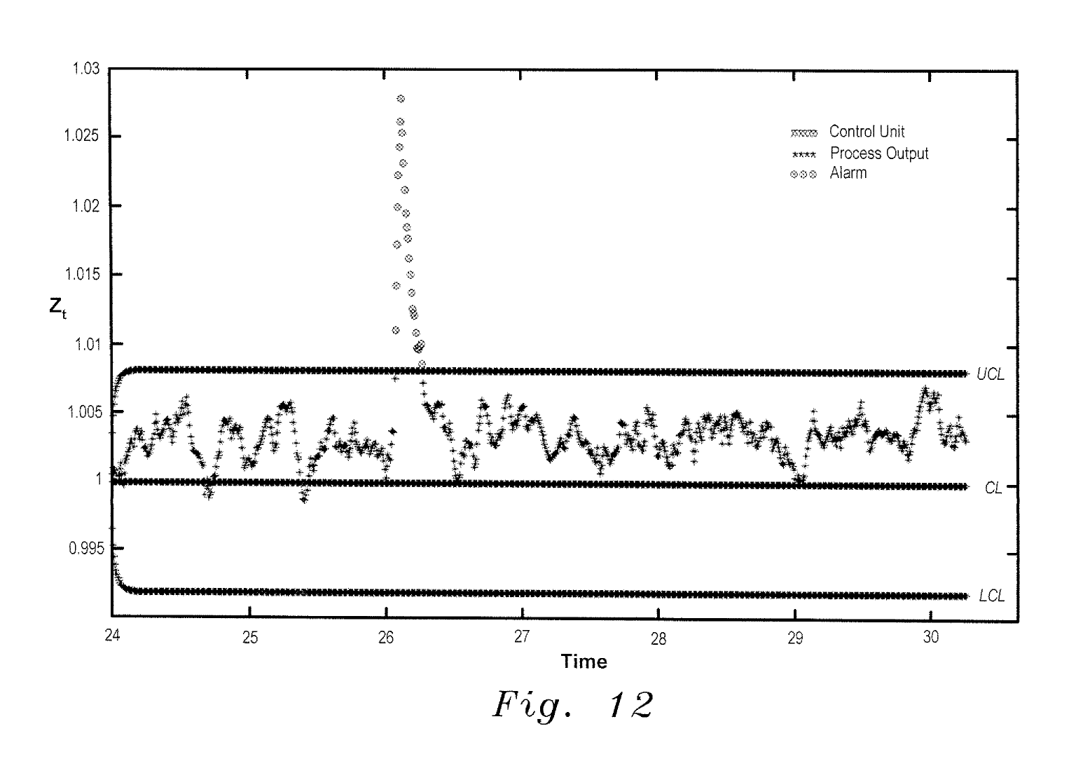

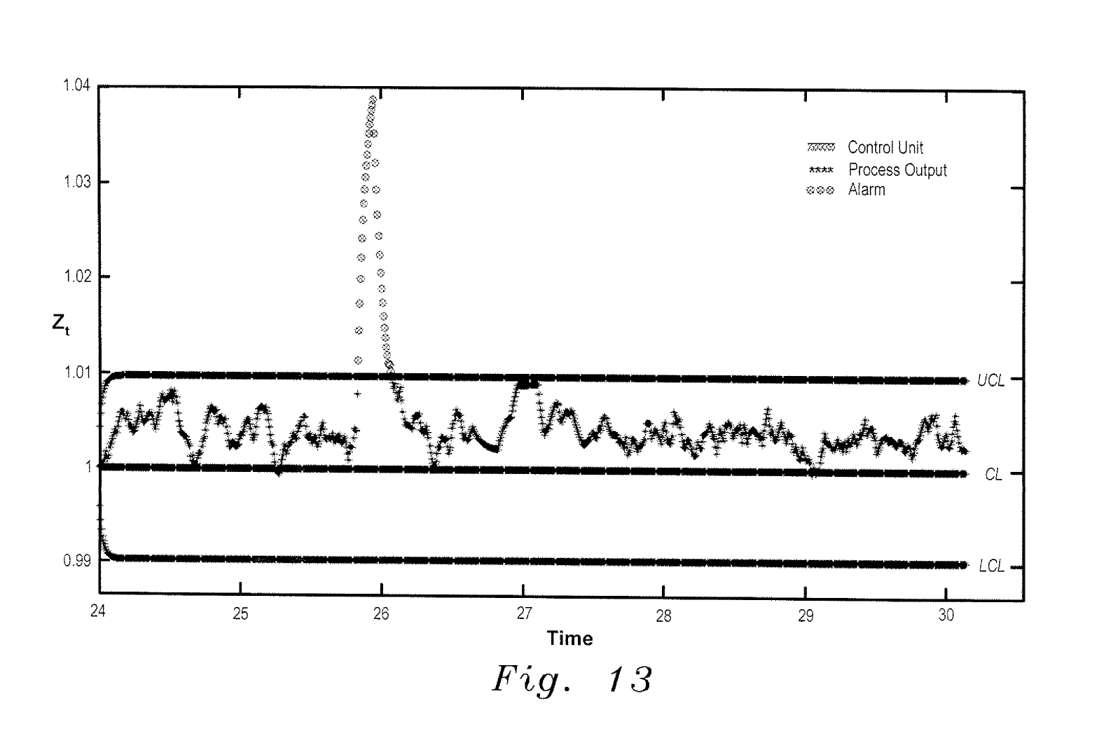

The process was next controlled by all three control schemes and was set to operate under assignable causes by introducing white noise and including a shift of 0.04 units in the process mean at t=26 sec. Exponentially-weighted moving average (EWMA) control charts for λ=0.1 and L=6 were generated, and their plots are respectively shown in FIGS. 11, 12 and 13.

The output statistics are summarized below in Table 8:

TABLE 8
Summary of results

| Control scheme | MSD | SNR | ARL | AE |
|---|---|---|---|---|
| PID control | 0.0537 | 12.7003 | 8.4350 | 0.7294 |
| SPC control | 0.0338 | 14.7108 | 17.9920 | 0.9235 |
| Fuzzy integrated SPC/APC | 0.0358 | 14.4612 | 19.6810 | 0.9641 |

These results indicate a decrease of 66.67% in MSD, an increase of 13.86% in the SNR, and an increase of 32.18% in the AE (and twice the increase in ARL). This indicates the effectiveness of the fuzzy-integrated SPC/APC system 10 over the existing PID control scheme and the SPC control scheme in terms of optimizing the level of quality, performance and robustness.

It is to be understood that the present invention is not limited to the embodiments described above, but encompasses any and all embodiments within the scope of the following claims.

We claim:

1. A method for process monitoring and control in an automated system having an automatic process controller, a statistical process controller, and a fuzzy logic controller, the method comprising the steps of:
feeding back an output error erₜ of the process as a first input to the fuzzy logic controller;
feeding back a rate of change of an output quality characteristic dyₜ of the process as a second input to the fuzzy logic controller;
applying a set of fuzzy inference rules in the fuzzy logic controller to produce a controller utilization factor wₜ as a fuzzy logic controller output;
inputting the controller utilization factor wₜ to the automatic process controller when the output error erₜ is below a fuzzy output error threshold and the rate of change of the output quality characteristic dyₜ is below a fuzzy output quality characteristic threshold so that process monitoring and control of the monitored process is controlled by the automatic process controller; and
inputting the controller utilization factor wₜ to the statistical process controller so that process monitoring and control of the monitored process is controlled by the statistical process controller when the output error erₜ is not below a fuzzy output error threshold or the rate of change of the output quality characteristic dyₜ is not below a fuzzy output quality characteristic threshold.

2. The method for process monitoring and control as recited in claim 1, wherein the set of fuzzy inference rules comprises:
if (erₜ is NMAX) and (dyₜ is NHI) then (wₜ is BIC);
if (erₜ is NMAX) and (dyₜ is NLO) then (wₜ is SAC);
if (erₜ is NMAX) and (dyₜ is ZERO) then (wₜ is SPC);
if (erₜ is NMAX) and (dyₜ is PLO) then (wₜ is SPC);
if (erₜ is NMAX) and (dyₜ is PHI) then (wₜ is SPC);
if (erₜ is NMIN) and (dyₜ is NHI) then (wₜ is BIC);
if (erₜ is NMIN) and (dyₜ is NLO) then (wₜ is SAC);
if (erₜ is NMIN) and (dyₜ is ZERO) then (wₜ is SAC);
if (erₜ is NMIN) and (dyₜ is PLO) then (wₜ w is SAC);
if (erₜ is NMIN) and (dyₜ is PHI) then (wₜ is SPC);
if (erₜ is ZERO) and (dyₜ is NHI) then (wₜ is SPC);
if (erₜ is ZERO) and (dyₜ is NLO) then (wₜ is SAC);
if (erₜ is ZERO) and (dyₜ is ZERO) then (wₜ is APC);
if (erₜ is ZERO) and (dyₜ is PLO) then (wₜ is SAC);
if (erₜ is ZERO) and (dyₜ is PHI) then (wₜ is SPC);
if (erₜ is PMIN) and (dyₜ is NHI) then (wₜ is SPC);
if (erₜ is PMIN) and (dyₜ is NLO) then (wₜ is SAC);
if (erₜ is PMIN) and (dyₜ is ZERO) then (wₜ is SAC);
if (erₜ is PMIN) and (dyₜ is PLO) then (wₜ is SAC);
if (erₜ is PMIN) and (dyₜ is PHI) then (wₜ is BIC);
if (erₜ is PMAX) and (dyₜ is NHI) then (wₜ is SPC);
if (erₜ is PMAX) and (dyₜ is NLO) then (wₜ is SPC);
if (erₜ is PMAX) and (dyₜ is ZERO) then (wₜ is SPC);
if (erₜ is PMAX) and (dyₜ is PLO) then (wₜ is SAC); and
if (erₜ is PMAX) and (dyₜ is PHI) then (wₜ is BIC),
wherein erₜ is divided into five membership functions including Negative High (NHI), Negative Low (NLO), Zero (ZERO), Positive Low (PLO), and Positive High (PHI), and dyₜ is also divided into five membership functions including Negative Maximum (NMAX), Negative Minimum (NMIN), Normal (NORM), Positive Minimum (PMIN), and Positive Maximum (PMAX), and wherein wₜ is further divided into five membership functions including Statistical Process Control (SPC), Larger Statistical Control (SAC), Both Control Schemes (BIC), Larger Automatic Control (ASC), and Automatic Process Control (APC).

3. The method for process monitoring and control as recited in claim 2, wherein the fuzzy logic controller performs a fuzzification step for converting the output error erₜ and the rate of change of the output quality characteristic dyₜ into a plurality of fuzzy represented values.

4. The method for process monitoring and control as recited in claim 3, wherein the fuzzy logic controller further performs a defuzzification step for generating the controller utilization factor wₜ as a non-fuzzy control action representative of a membership function of an inferred fuzzy control action.

5. The method for process monitoring and control as recited in claim 4, wherein the defuzzification step comprises a center of area calculation for a distribution for the control action, given by
$${Z}^{*} = \frac{{\sum }_{j = 1}^{q} {z}_{j} {μ}_{c} ( {z}_{j} )}{{\sum }_{j = 1}^{q} {μ}_{c} ( {z}_{j} )} ,$$
wherein Z* represents a number of quantization levels of the output, zⱼ represents an amount of control output at a quantization level j, and μ_{c} (zⱼ) represents a membership value in variable C.

6. The method for process monitoring and control as recited in claim 5, further comprising the step of generating a final control action u(t) as u(t)=wₜ·u_{APC}(t)+[1−w(t)]·u_{SPC}(t), wherein u_{SPC}(t) represents a control action from the statistical process controller, and u_{APC}(t) represents a control action from the automatic process controller, wherein 0≦wₜ≦1.

7. A system for process monitoring and control, comprising:
an automatic process controller monitoring and controlling a monitored process;
a statistical process controller; and
a fuzzy logic controller in communication with the automatic process controller, the fuzzy logic controller having first and second fuzzy logic controller inputs from the automatic process controller and a fuzzy logic controller output, wherein the first fuzzy logic controller input is output error erₜ of the monitored process, the second fuzzy logic controller input is the rate of change of an output quality characteristic dyₜ, and the fuzzy logic controller output is a controller utilization factor wₜ,
wherein the fuzzy logic controller applies a set of fuzzy inference rules so that process monitoring and control of the monitored process is controlled by the automatic process controller and the controller utilization factor wₜ is input to the automatic process controller when the output error erₜ is below a fuzzy output error threshold and the rate of change of the output quality characteristic dyₜ is below a fuzzy output quality characteristic threshold, otherwise the process monitoring and control of the monitored process is controlled by the statistical process controller and the controller utilization factor wₜ is input to the statistical process controller.

8. The system for process monitoring and control as recited in claim 1, wherein the set of fuzzy inference rules comprises:
if (erₜ is NMAX) and (dyₜ is NHI) then (wₜ is BIC);
if (erₜ is NMAX) and (dyₜ is NLO) then (wₜ is SAC);
if (erₜ is NMAX) and (dyₜ is ZERO) then (wₜ is SPC);
if (erₜ is NMAX) and (dyₜ is PLO) then (wₜ is SPC);
if (erₜ is NMAX) and (dyₜ is PHI) then (wₜ is SPC);
if (erₜ is NMIN) and (dyₜ is NHI) then (wₜ is BIC);
if (erₜ is NMIN) and (dyₜ is NLO) then (wₜ is SAC);
if (erₜ is NMIN) and (dyₜ is ZERO) then (wₜ is SAC);
if (erₜ is NMIN) and (dyₜ is PLO) then (wₜ w is SAC);
if (erₜ is NMIN) and (dyₜ is PHI) then (wₜ is SPC);
if (erₜ is ZERO) and (dyₜ is NHI) then (wₜ is SPC);
if (erₜ is ZERO) and (dyₜ is NLO) then (wₜ is SAC);
if (erₜ is ZERO) and (dyₜ is ZERO) then (wₜ is APC);
if (erₜ is ZERO) and (dyₜ is PLO) then (wₜ is SAC);
if (erₜ is ZERO) and (dyₜ is PHI) then (wₜ is SPC);
if (erₜ is PMIN) and (dyₜ is NHI) then (wₜ is SPC);
if (erₜ is PMIN) and (dyₜ is NLO) then (wₜ is SAC);
if (erₜ is PMIN) and (dyₜ is ZERO) then (wₜ is SAC);
if (erₜ is PMIN) and (dyₜ is PLO) then (wₜ is SAC);
if (erₜ is PMIN) and (dyₜ is PHI) then (wₜ is BIC);
if (erₜ is PMAX) and (dyₜ is NHI) then (wₜ is SPC);
if (erₜ is PMAX) and (dyₜ is NLO) then (wₜ is SPC);
if (erₜ is PMAX) and (dyₜ is ZERO) then (wₜ is SPC);
if (erₜ is PMAX) and (dyₜ is PLO) then (wₜ is SAC); and
if (erₜ is PMAX) and (dyₜ is PHI) then (wₜ is BIC),
wherein erₜ is divided into five membership functions including Negative High (NHI), Negative Low (NLO), Zero (ZERO), Positive Low (PLO), and Positive High (PHI), and dyₜ is also divided into five membership functions including Negative Maximum (NMAX), Negative Minimum (NMIN), Normal (NORM), Positive Minimum (PMIN), and Positive Maximum (PMAX), and wherein wₜ is further divided into five membership functions including Statistical Process Control (SPC), Larger Statistical Control (SAC), Both Control Schemes (BIC), Larger Automatic Control (ASC), and Automatic Process Control (APC).

9. The system for process monitoring and control as recited in claim 8, wherein the fuzzy logic controller comprises a fuzzification module for converting the output error erₜ and the rate of change of the output quality characteristic dyₜ into a plurality of fuzzy represented values.

10. The system for process monitoring and control as recited in claim 9, wherein the fuzzy logic controller further comprises a defuzzification module for generating the controller utilization factor wₜ as a non-fuzzy control action representative of a membership function of an inferred fuzzy control action.

11. The system for process monitoring and control as recited in claim 10, wherein the defuzzification module comprises means for performing a center of area calculation for a distribution for the control action, given by
$${Z}^{*} = \frac{{\sum }_{j = 1}^{q} {z}_{j} {μ}_{c} ( {z}_{j} )}{{\sum }_{j = 1}^{q} {μ}_{c} ( {z}_{j} )} ,$$
wherein Z* represents a number of quantization levels of the output, zⱼ represents an amount of control output at a quantization level j, and μ_{c}(zⱼ) represents a membership value in variable C.

12. The system for process monitoring and control as recited in claim 11, wherein said fuzzy logic controller further comprises means for generating a final control action u(t) as u(t)=wₜ·u_{APC}(t)+[1−w(t)]·u_{SPC}(t), wherein u_{SPC}(t) represents a control action from the statistical process controller, and u_{APC}(t) represents a control action from the automatic process controller, wherein 0≦wₜ≦1.
